(19) United States
(12) Patent Application Publication
(10) Pub. No.: US 2026/0043475 A1
(43) Pub. Date: Feb. 12, 2026

(54) SEALING STRUCTURE OF VEHICLE COMPONENT

(71) Applicant: TOYODA GOSEI CO., LTD., Kiyosu-shi (JP)

(72) Inventors: Moe SHIMOKAWA, Kiyosu-shi (JP); Atsushi KUMO, Kiyosu-shi (JP); Koji TATEMATSU, Kiyosu-shi (JP)

(21) Appl. No.: 19/264,092

(22) Filed: Jul. 9, 2025

(30) Foreign Application Priority Data
Aug. 6, 2024 (JP) 2024-129801

(51) Int. Cl. F16J 15/10; B60R 13/06

(52) U.S. Cl. CPC F16J 15/104; B60R 13/06

(57) ABSTRACT

A sealing structure of a vehicle component includes a first member, a second member, and a seal member. The first member includes an annular first peripheral wall and a first opening. The second member includes an annular second peripheral wall and a second opening. The second member covers the first member. The seal member includes a base portion and a lip portion. The base portion includes an inner surface in contact with the outer surface of the first peripheral wall. The lip portion protrudes from the outer surface of the base portion and includes a distal end in contact with an inner surface of the second peripheral wall. A projection for defining the position of the seal member in an insertion direction of the first member is provided on the outer surface of the first peripheral wall.

### CROSS-REFERENCE TO RELATED APPLICATIONS

This application is based upon and claims the benefit of priority from Japanese Patent Application No. 2024-129801, filed on Aug. 6, 2024, the entire contents of which are incorporated herein by reference.

### BACKGROUND

### 1. Field

The present disclosure relates to a sealing structure of a vehicle component.

### 2. Description of Related Art

Japanese Laid-Open Patent Publication No. 2020-159932 discloses a typical sealing structure of this type. In such a sealing structure, a first sealing portion is disposed between a sensor cover and a front grille of a vehicle to prevent water from adhering to the front surface of a near-infrared sensor. As a general approach, sealing structures of this kind typically include a seal member made of an elastic material disposed between two members to be sealed, namely, a first member and a second member.

In some cases, the aforementioned typical sealing structure is formed by assembling the second member with the first member while the seal member is disposed on an outer surface of the first member. In such cases, if the position of the seal member is not pre-defined on the outer surface of the first member, the second member may be assembled with the first member while the seal member is displaced from its intended position. As a result, the sealing performance provided by the seal member may not be reliably ensured.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a sealing structure of a vehicle component includes a first member, a second member, and a seal member. The first member includes an annular first peripheral wall and a first opening. The second member includes an annular second peripheral wall and a second opening. The second member covers the first member such that the second peripheral wall is located on an outer side of the first peripheral wall when the first member is inserted into the second member through the second opening. The seal member is formed in an annular shape, made of an elastic material, and disposed on an outer surface of the first peripheral wall to provide a seal between the first peripheral wall and the second peripheral wall. The seal member includes a base portion including an inner surface in contact with the outer surface of the first peripheral wall, and a lip portion protruding from an outer surface of the base portion and including a distal end in contact with an inner surface of the second peripheral wall. A projection for defining a position of the seal member in an insertion direction of the first member is provided on the outer surface of the first peripheral wall.

Other features and aspects will be apparent from the following detailed description, the drawings, and the claims.

### BRIEF DESCRIPTION OF THE DRAWINGS

FIG. 1 is a cross-sectional view of a vehicle component according to a first embodiment.

FIG. 2 is a plan view of a first member according to the first embodiment.

FIG. 3 is a cross-sectional view of a main portion of the first embodiment, illustrating a state in which the first member, with a seal member disposed thereon, is being inserted into a second member.

FIG. 4 is a cross-sectional view of a vehicle component according to a second embodiment.

FIG. 5 is a plan view of a first member according to the second embodiment.

FIG. 6 is a cross-sectional view of a main portion of the second embodiment, illustrating a state in which the first member, with a seal member disposed thereon, is being inserted into a second member.

FIG. 7 is a cross-sectional view of the main portion of the second embodiment, illustrating a state in which the first member is inserted further into a second member from the state shown in FIG. 6.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

The term “annular” as used in this description may refer to any structure that forms a loop, which is a continuous shape with no ends. “Annular” shapes include but are not limited to a circular shape, an elliptic shape, and a polygonal shape with sharp or rounded corners.

### FIRST EMBODIMENT

A first embodiment will now be described with reference to the drawings.

### Vehicle Component 11

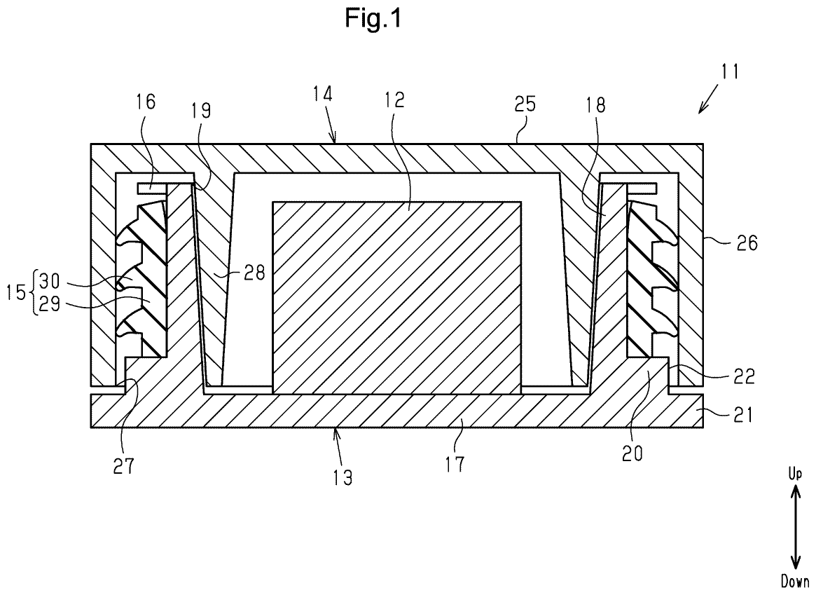

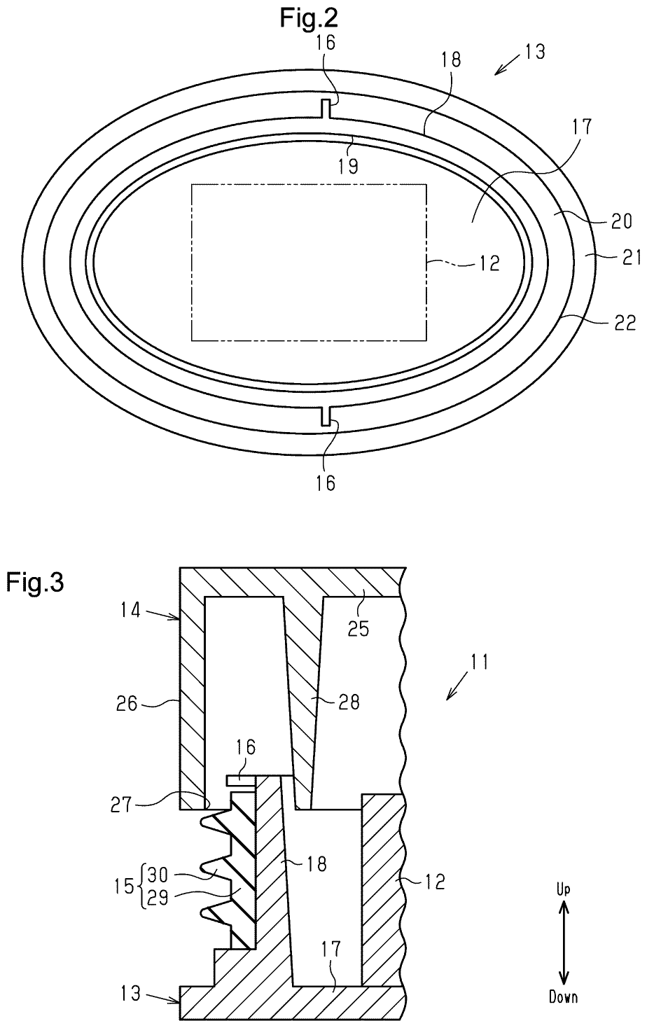

As shown in FIGS. 1 and 2, for example, a vehicle component 11 accommodates a contained object 12 that is susceptible to water damage, such as various types of sensors (e.g., millimeter wave sensors) or circuit boards, which are mounted in a vehicle. The vehicle component 11 protects the contained object 12 from water ingress. Specifically, the vehicle component 11 protects the contained object 12 from water by use of a sealing structure. The vehicle component 11 includes a first member 13, a second member 14, a seal member 15, and a projection 16. The vehicle component 11 has, for example, an elliptical shape in plan view.

The vertical direction in the following description is based on the vertical direction of the vehicle component 11 shown in FIG. 1. Accordingly, the vehicle component 11 of the present embodiment has a structure in which the second member 14 is assembled on the upper side of the first member 13.

### The First Member 13 and the Projection 16

As shown in FIGS. 1 and 2, the first member 13 is made of, for example, a plastic and has the shape of an elliptical box with a closed end. Specifically, the first member 13 includes an elliptical first bottom wall 17, an elliptical annular first peripheral wall 18 provided on the upper surface of the first bottom wall 17, and a first opening 19 opened at the upper end of the first peripheral wall 18. The peripheral edge of the first bottom wall 17 includes a first peripheral edge portion 20 and a second peripheral edge portion 21. The first peripheral edge portion 20 projects radially outward beyond the first peripheral wall 18 and is adjacent to the radially outer side of the first peripheral wall 18. The second peripheral edge portion 21 is adjacent to the radially outer side of the first peripheral edge portion 20.

The height of the upper surface of the first peripheral edge portion 20 is higher than the height of the upper surface of the second peripheral edge portion 21. Accordingly, a step surface 22 is formed between the first peripheral edge portion 20 and the second peripheral edge portion 21. The height of the upper surface of the first bottom wall 17 on the inner side of the first peripheral wall 18 is the same as the height of the upper surface of the second peripheral edge portion 21. The contained object 12 is disposed in a fixed state at a section of the upper surface of the first bottom wall 17 that is on the inner side of the first peripheral wall 18. The height of the contained object 12 is lower than the height of the first peripheral wall 18.

The outer surface of the first peripheral wall 18 is parallel to the vertical direction. The inner surface of the first peripheral wall 18 is slightly inclined with respect to the vertical direction so as to be located further outward toward the upper end. Rectangular parallelepiped projections 16 are provided at the upper end of the outer surface of the first peripheral wall 18. The projections 16 are respectively disposed on the outer surface of the first peripheral wall 18 at positions opposite to each other across a central portion of the first member 13.

In other words, in plan view, the two projections 16 are disposed in the vicinity of the extension line of the minor axis of the ellipse formed by the first peripheral wall 18. The projections 16 project radially outward from the outer surface of the first peripheral wall 18. The projections 16 are formed integrally with the first peripheral wall 18, for example.

### The Second Member 14

As shown in FIG. 1, the second member 14 is made of, for example, a plastic and has the shape of an elliptical box with a closed end. Specifically, the second member 14 includes an elliptical second bottom wall 25, an elliptical annular second peripheral wall 26 provided on the lower surface of the second bottom wall 25, and a second opening 27 opened at the lower end of the second peripheral wall 26. The second member 14 covers the first member 13 such that the second peripheral wall 26 is located on the outer side of the first peripheral wall 18 when the first member 13 is inserted into the second member 14 through the second opening 27.

The lower surface of the second peripheral wall 26 faces the upper surface of the second peripheral edge portion 21 of the first member 13 when the first member 13 is covered with the second member 14. In this case, a slight gap is formed between the lower surface of the second peripheral wall 26 and the upper surface of the second peripheral edge portion 21. An elliptic annular rib 28 is provided at section of the lower surface of the second bottom wall 25 that is on the inner side of the second peripheral wall 26. The rib 28 includes an outer surface that can come into contact with the inner surface of the first peripheral wall 18 when the first member 13 is inserted into the second member 14 through the second opening 27.

The lower surface of the rib 28 faces a section of the upper surface of the first bottom wall 17 that is on the inner side of the first peripheral wall 18 when the first member 13 is inserted into the second member 14 through the second opening 27. In this case, a slight gap is formed between the lower surface of the rib 28 and a section of the upper surface of the first bottom wall 17 that is on the inner side of the first peripheral wall 18. The outer surface of the rib 28 is slightly inclined with respect to the vertical direction so as to be located further inward toward the lower end. The inner surface of the rib 28 is slightly inclined with respect to the vertical direction so as to be located further outward toward the lower end.

The lower surface of the second bottom wall 25, between the second peripheral wall 26 and the rib 28, faces the upper surface of the first peripheral wall 18 when the first member 13 is inserted into the second member 14 through the second opening 27. In this case, a slight gap is formed between the lower surface of the second bottom wall 25, between the second peripheral wall 26 and the rib 28, and the upper surface of the first peripheral wall 18. Further, in this case, a slight gap is formed between the inner surface of the first peripheral wall 18 and the outer surface of the rib 28.

### The Seal Member 15

As shown in FIG. 1, the seal member 15 has an elliptical annular shape and is made of an elastic material such as silicone rubber. The seal member 15 is disposed in close contact with the outer surface of the first peripheral wall 18 by its elastic force, thereby providing a seal between the first peripheral wall 18 and the second peripheral wall 26 when the first member 13 is inserted into the second member 14 through the second opening 27.

The seal member 15 includes an elliptical annular base portion 29 and multiple (three in this example) elliptical annular lip portions 30. The inner surface of the base portion 29 is in contact with the outer surface of the first peripheral wall 18. The lip portions 30 protrude from the outer surface of the base portion 29 and each include a distal end in contact with the inner surface of the second peripheral wall 26. The lower surface of the base portion 29 is in contact with the upper surface of the first peripheral edge portion 20. The upper surface of the base portion 29 faces the lower surface of the projections 16 with slight gaps therebetween.

When the seal member 15 is attached to the outer surface of the first peripheral wall 18 by its elastic force, the projections 16 define the position of the seal member 15 in the vertical direction, which is the insertion direction of the first member 13 into the second member 14. Specifically, when the seal member 15 is attached to the outer surface of the first peripheral wall 18, the position of the seal member 15 is defined in the vertical direction by being disposed below the projections 16.

The elliptical annular lip portions 30 protrude radially outward so as to be arranged at equal intervals in the vertical direction between the upper end and the lower end of the outer surface of the base portion 29. The distal ends of the lip portions 30 project radially outward beyond the step surface 22.

### Operation of the First Embodiment

Operation during assembly of the vehicle component 11 will now be described.

As shown in FIG. 3, when the vehicle component 11 is assembled, the seal member 15 is first disposed on the outer surface of the first peripheral wall 18 of the first member 13 by elastic force of the seal member 15. At this time, the seal member 15 is disposed on the outer surface of the first peripheral wall 18 such that the upper end of the seal member 15 is located below the projections 16. As a result, the seal member 15 is disposed on the outer surface of the first peripheral wall 18 with its position defined in the vertical direction.

Next, the contained object 12 is disposed on and fixed to the central portion of the upper surface of the first bottom wall 17 inside the first peripheral wall 18 of the first member 13. Subsequently, the second member 14 is moved so as to cover the first member 13 from above, so that the first member 13 is inserted into the second member 14 through the second opening 27. Then, as shown in FIG. 1, the contained object 12 is inserted into the space inside the rib 28 of the second member 14, and the first peripheral wall 18 with the seal member 15 disposed on the outer surface thereof is inserted into the space between the rib 28 and the second peripheral wall 26 of the second member 14.

When the second member 14 is fully assembled with the first member 13, the vehicle component 11 shown in FIG. 1 is assembled. At this time, as described above, since the seal member 15 is disposed on the outer surface of the first peripheral wall 18 with its vertical position defined by the projections 16, the seal member 15 is accurately at its intended position between the first peripheral wall 18 and the second peripheral wall 26. Accordingly, the seal member 15 reliably ensures the sealing performance between the first peripheral wall 18 and the second peripheral wall 26 in the vehicle component 11.

### Advantages of the First Embodiment

The above described first embodiment achieves the following advantages.

(1-1) In the sealing structure of the vehicle component 11, the projections 16 for defining the position of the seal member 15 in the insertion direction of the first member 13 are provided on the outer surface of the first peripheral wall 18.

With this configuration and the operation of the first embodiment, when the seal member 15 is disposed on the outer surface of the first peripheral wall 18, the position of the seal member 15 is defined in the vertical direction by the projections 16. Therefore, when the second member 14 is fully assembled with the first member 13 to assemble the vehicle component 11 shown in FIG. 1, the seal member 15 is accurately disposed at its intended position between the first peripheral wall 18 and the second peripheral wall 26. Accordingly, the seal member 15 reliably ensures the sealing performance between the first peripheral wall 18 and the second peripheral wall 26 in the vehicle component 11.

(1-2) In the sealing structure of the vehicle component 11, the annular rib 28 is provided at a section of the second bottom wall 25 that is on the inner side of the second peripheral wall 26. The annular rib 28 has the outer surface that can come into contact with the inner surface of the first peripheral wall 18 when the first member 13 is inserted into the second member 14.

With this configuration, the second member 14 is reinforced by the rib 28. In addition, when the first member 13 is inserted into the second member 14, the outer surface of the rib 28 is slid on the inner surface of the first peripheral wall 18, which allows the first member 13 to be smoothly inserted into the second member 14. Further, after the first member 13 is inserted into the second member 14, the inner surface of the first peripheral wall 18 and the outer surface of the rib 28 are brought into contact with each other, so that the position of the second member 14 is defined with respect to the first member 13 in a planar direction of the second bottom wall 25, which is the horizontal direction orthogonal to the vertical direction. This ensures the contact pressure of the lip portions 30 of the seal member 15 against the inner surface of the second peripheral wall 26.

(1-3) In the sealing structure of the vehicle component 11, the projections 16 are respectively disposed on the first peripheral wall 18 at positions opposite to each other across the central portion of the first member 13.

With this configuration, the projections 16 allow the position of the seal member 15 to be defined in a balanced manner when the first member 13 is inserted into the second member 14.

(1-4) In the sealing structure of the vehicle component 11, the multiple lip portions 30 protrude from the outer surface of the base portion 29 at intervals.

This configuration contributes to the improvement of the sealing performance of the seal member 15.

### SECOND EMBODIMENT

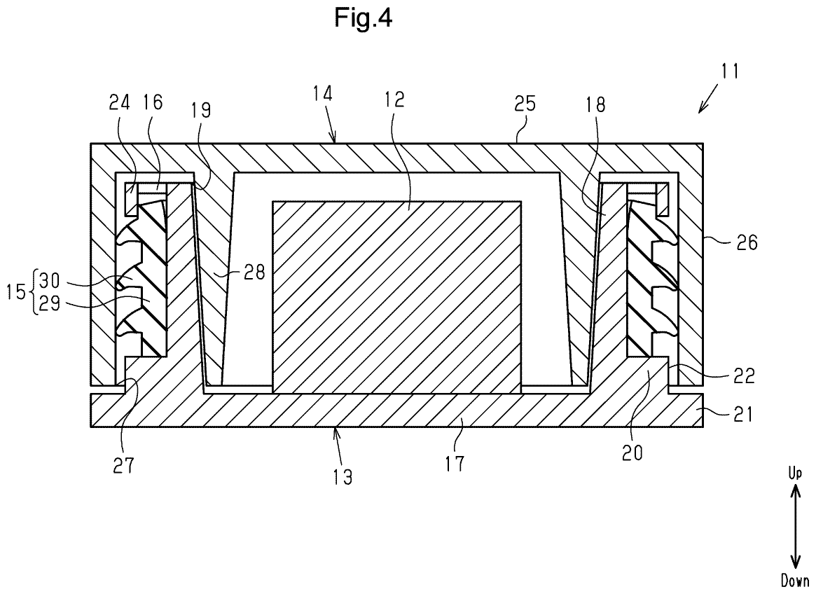

As shown in FIG. 4, a second embodiment is the same as the first embodiment except that an extension portion 24 is provided at the distal end of each projection 16 in the second embodiment. Thus, only the differences of the second embodiment from the first embodiment will be described, and redundant descriptions will be omitted. The same reference numerals are given to the components of the second embodiment that are the same as the corresponding components of the first embodiment.

### The Extension Portions 24

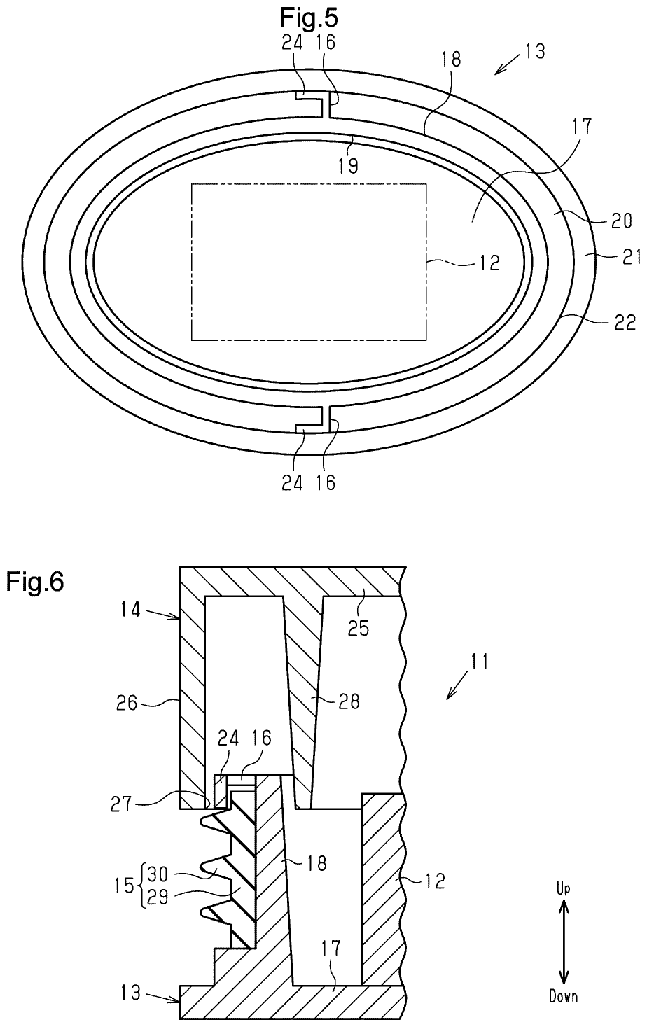

As shown in FIGS. 4 and 5, the extension portions 24 are provided integrally with the projections 16 at the distal ends of the projections 16. Each extension portion 24 has the shape of a rectangular plate and extends from the distal end of the corresponding projection 16 in the circumferential direction of the first peripheral wall 18. In plan view, the extension portions 24 are disposed on the extension line of the minor axis of the ellipse formed by the first peripheral wall 18. The extension portions 24 face the outer surface of the first peripheral wall 18 in the radial direction of the first peripheral wall 18. The lower ends of the extension portions 24 are located below the lower ends of the projections 16.

### The Seal Member 15

As shown in FIG. 6, the outer surface of the leading end of the base portion 29 of the seal member 15 in the insertion direction of the first member 13 into the second member 14, that is, the outer surface of the upper end of the base portion 29, faces the inner surface of each extension portion 24. The upper end of the base portion 29 is located between the outer surface of the upper end of the first peripheral wall 18 and the inner surface of each extension portion 24.

Therefore, as shown in FIG. 4, when the first member 13 is inserted into the second member 14 through the second opening 27, the outer surface of the upper end of the base portion 29 comes into contact with the inner surfaces of the extension portions 24 even if the upper end of the base portion 29 is moved toward the second peripheral wall 26, which is on the radially outer side. Therefore, the extension portions 24 limit the radially outward movement of the upper end of the base portion 29.

### Operation of the Second Embodiment

Operation during assembly of the vehicle component 11 will now be described.

As shown in FIG. 6, when the vehicle component 11 is assembled, the seal member 15 is first disposed on the outer surface of the first peripheral wall 18 of the first member 13 by elastic force of the seal member 15. Next, the contained object 12 is disposed on and fixed to the central portion of the upper surface of the first bottom wall 17 inside the first peripheral wall 18 of the first member 13. Subsequently, the second member 14 is moved so as to cover the first member 13 from above, so that the first member 13 is inserted into the second member 14 through the second opening 27.

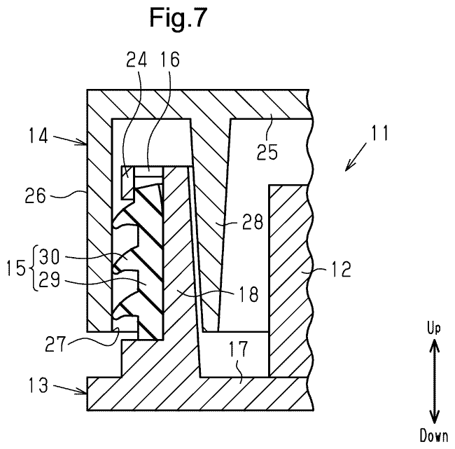

Then, as shown in FIG. 7, the contained object 12 is inserted into the space inside the rib 28 of the second member 14, and the first peripheral wall 18 with the seal member 15 disposed on the outer surface thereof is inserted into the space between the rib 28 and the second peripheral wall 26 of the second member 14. At this time, the movement of the second member 14 with respect to the first member 13 is guided by sliding the outer surface of the rib 28 on the inner surface of the first peripheral wall 18.

Further, at this time, due to the friction between the inner surface of the second peripheral wall 26 and the distal ends of the lip portions 30 of the seal member 15, the lip portions 30 are pulled downward along with the movement of the second member 14. As a result, a force acts on the seal member 15 that tends to bend the upper end radially outward. Accordingly, the seal member 15 bends radially outward from the upper end. However, the outer surface of the upper end of the base portion 29 comes into contact with the inner surfaces of the extension portions 24 to prevent further radially outward bending of the upper end of the seal member 15.

Subsequently, when the second member 14 is fully assembled with the first member 13 by moving the second member 14 downward, the vehicle component 11 shown in FIG. 4 is assembled. At this time, as in the above-described case, a force acts on the seal member 15 that tends to bend the upper end radially outward. However, the outer surface of the upper end of the base portion 29 is already in contact with the inner surfaces of the extension portions 24, so as to prevent further radially outward bending of the upper end of the seal member 15.

Accordingly, in the vehicle component 11, the seal member 15 is disposed at its intended position and retains its intended shape between the first peripheral wall 18 and the second peripheral wall 26. As a result, the seal member 15 reliably ensures the sealing performance between the first peripheral wall 18 and the second peripheral wall 26 in the vehicle component 11.

Additionally, during complete assembly of the second member 14 with the first member 13, air present on the inner side of the rib 28 of the second member 14 is discharged to the outside through the gap between the lower surface of the rib 28 and the upper surface of the first bottom wall 17 located inside the first peripheral wall 18, the gap between the outer surface of the rib 28 and the inner surface of the first peripheral wall 18, the gap between the lower surface of the second bottom wall 25, between the second peripheral wall 26 and the rib 28, and the upper surface of the first peripheral wall 18, and the gap between the lower surface of the second peripheral wall 26 and the upper surface of the second peripheral edge portion 21.

Therefore, resistance caused by the air present between the first member 13 and the second member 14 during assembly of the second member 14 with the first member 13 is reduced. As a result, the force required to assemble the second member 14 with the first member 13 is reduced, thereby improving workability.

If the air on the inner side of the rib 28 of the second member 14 is not discharged to the outside during assembly of the second member 14 with the first member 13, the resistance caused by the air present between the first member 13 and the second member 14 increases. Consequently, the force required to assemble the second member 14 with the first member 13 also increases, resulting in decreased workability.

### Advantages of the Second Embodiment

In addition to the above described advantages (1-1) to (1-4), the second embodiment achieves the following advantages.

(2-1) The sealing structure of the vehicle component 11 includes the extension portions 24, which are provided at the distal ends of the projections 16 provided on the outer surface of the first peripheral wall 18. The extension portions 24 limit radially outward movement of the upper end of the base portion 29 of the seal member 15, which is the leading end of the base portion 29 in the insertion direction of the first member 13.

With this configuration and the operation of the second embodiment, the extension portions 24 limit radially outward movement of the upper end of the base portion 29 of the seal member 15 when the second member 14 is assembled with the first member 13. Accordingly, in the vehicle component 11, the seal member 15 is disposed at its intended position and retains its intended shape between the first peripheral wall 18 and the second peripheral wall 26. Accordingly, the seal member 15 reliably ensures the sealing performance between the first peripheral wall 18 and the second peripheral wall 26 in the vehicle component 11.

(2-2) In the sealing structure of the vehicle component 11, the extension portions 24 are respectively disposed on the first peripheral wall 18 via the projections 16 at positions opposite to each other across the central portion of the first member 13.

With this configuration, the extension portions 24 limit, in a balanced manner, bending of the seal member 15 toward the second peripheral wall 26, which is located on the radially outer side, during insertion of the first member 13 into the second member 14.

### Modifications

The above-described embodiments may be modified as described below. The above-described embodiments and the following modifications can be combined as long as the combined modifications remain technically consistent with each other.

The lip portions 30 do not necessarily need to protrude from the outer surface of the base portion 29 at equal intervals. That is, multiple lip portions 30 may protrude from the outer surface of the base portion 29 at different intervals.

The number of lip portions 30 protruding from the outer surface of the base portion 29 may be one, two, or greater than three.

Two or more projections 16 may be disposed at each of two opposite positions on the first peripheral wall 18 across the central portion of the first member 13.

Multiple projections 16 may be arranged at appropriate intervals over the entire circumference of the first peripheral wall 18.

The rib 28 may be omitted from the second member 14.

The first bottom wall 17 may be omitted from the first member 13, and the second bottom wall 25 may be omitted from the second member 14. In this case, the first member 13 and the second member 14 both have a tubular shape.

The shape of the vehicle component 11 in plan view is not limited to an elliptical shape, but may alternatively be, for example, a true circular shape, or a polygonal shape such as a rectangular or hexagonal shape.

The vehicle component 11 is not limited to use in a configuration in which the first member 13 and the second member 14 are arranged in the vertical direction, but may alternatively be used in a configuration in which the first member 13 and the second member 14 are arranged in the horizontal direction orthogonal to the vertical direction.

The projections 16 may be formed as members separate from the first peripheral wall 18. In this case, the projections 16 are fixed to the first peripheral wall 18 by using, for example, screws or adhesive.

The extension portions 24 may be provided so as to extend downward from the distal ends of the projections 16. In this case, a projection 16 may be provided on the first peripheral wall 18 so as to extend over the entire circumference of the first peripheral wall 18.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A sealing structure of a vehicle component, comprising:
a first member including an annular first peripheral wall and a first opening;
a second member including an annular second peripheral wall and a second opening, the second member covering the first member such that the second peripheral wall is located on an outer side of the first peripheral wall when the first member is inserted into the second member through the second opening; and
a seal member formed in an annular shape, made of an elastic material, and disposed on an outer surface of the first peripheral wall to provide a seal between the first peripheral wall and the second peripheral wall, wherein
the seal member includes:
a base portion including an inner surface in contact with the outer surface of the first peripheral wall; and
a lip portion protruding from an outer surface of the base portion and including a distal end in contact with an inner surface of the second peripheral wall, and
a projection for defining a position of the seal member in an insertion direction of the first member is provided on the outer surface of the first peripheral wall.

2. The sealing structure of the vehicle component according to claim 1, wherein
the first member includes a first bottom wall,
the second member includes a second bottom wall, and
an annular rib is provided at a section of the second bottom wall that is on an inner side of the second peripheral wall, the annular rib having an outer surface capable of coming into contact with an inner surface of the first peripheral wall when the first member is inserted into the second member.

3. The sealing structure of the vehicle component according to claim 1, wherein
the projection is one of multiple projections that are provided on the outer surface of the first peripheral wall and configured to define the position of the seal member in the insertion direction, and
the projections include projections disposed on the first peripheral wall at positions opposite to each other across a central portion of the first member.

4. The sealing structure of the vehicle component according to claim 1, wherein the lip portion is one of multiple lip portions protruding from the outer surface of the base portion so as to be arranged at intervals, the distal ends of the lip portions being in contact with the inner surface of the second peripheral wall.
